(19) United States
(12) Patent Application Publication
(10) Pub. No.: US 2006/0059031 A1
(43) Pub. Date: Mar. 16, 2006

(54) Risk management

(75) Inventors: Martin Hertel-Szabadi, Heidelberg (DE); Michael Grass, Nussloch (DE)

Correspondence Address: FOLEY & LARDNER LLP, 777 EAST WISCONSIN AVENUE, SUITE 3800, MILWAUKEE, WI, 53202-5308, US

(73) Assignee: SAP Aktiengesellschaft

(21) Appl. No.: 10/913,645

(22) Filed: Aug. 6, 2004

(51) Int. Cl. G07G 1/00

(52) U.S. Cl. 705/10

(57) ABSTRACT

A method of performing risk assessment for a service provider, includes creating a sales prospect. The method also includes determining conflicts and risks for the prospect based on answering a plurality of questions relating to the prospect. The method further includes determining whether or not the prospect should be allowed as a new client based on the determined conflicts and risks. If the prospect is determined to be allowable as a new client, the method includes: a) determining conflicts and risks for an opportunity to be performed for the prospect based on answering a plurality of questions related to the opportunity, and b) based on the determined conflicts and risks, either accepting the opportunity or not accepting the opportunity.

### BACKGROUND OF THE INVENTION

A. Field of the Invention

The present invention is directed to the field of risk assessment.

B. Background

Risk assessment is an important thing to do for companies, especially for service-oriented companies like law firms and accounting firms.

In particular, when a prospective new client or prospective new customer contacts a company for a service to be performed by the company for the new client or new customer, a risk assessment should be performed to determine whether or not the prospective new client or prospective new customer should become an actual client or an actual customer of the company.

There exist various types of conventional risk assessment tools, whereby these tools provide some degree of risk assessment. This is especially true for law firms, whereby ethical standards and legal standards mandate that a law firm not take on a matter that may be detrimental to an existing client.

There is a desire to provide a better risk assessment tool for a company.

### SUMMARY OF THE INVENTION

The present invention, as described herein, provides a method and system for performing risk assessment of a prospective new client or customer.

According to one aspect of the invention there is provided a method of performing risk assessment for a service provider, which includes creating a sales prospect. The method also includes determining conflicts and risks for the prospect based on answering a plurality of questions relating to the prospect. The method further includes determining whether or not the prospect should be allowed as a new client based on the determined conflicts and risks. If the prospect is determined to be allowable as a new client, the method includes: a) determining conflicts and risks for an opportunity to be performed for the prospect based on answering a plurality of questions related to the opportunity, b) based on the determined conflicts and risks, either accepting the opportunity or not accepting the opportunity.

According to another aspect of the invention, there is provided a system for performing risk assessment for a service provider. The system includes a first database for creating a sales prospect. The system also includes a second database for determining conflicts and risks for the prospect based on answers to a plurality of questions relating to the prospect. The first database determines whether or not the prospect should be allowed as a new client based on the determined conflicts and risks. The system further includes a third database for creating a new customer corresponding to the prospect when the first database determines that the prospect should be allowed as a new client.

Other features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The foregoing advantages and features of the invention will become apparent upon reference to the following detailed description and the accompanying drawings, of which:

FIG. 1 illustrates a risk classification breakdown according to an embodiment of the invention;

FIG. 2 illustrates a business objects risk assessment breakdown according to an embodiment of the invention;

FIG. 3 illustrates a technical steps risk assessment breakdown according to an embodiment of the invention;

FIG. 4 illustrates various purposes for risk assessment according to an embodiment of the invention;

FIG. 5 illustrates steps and databases involved in performing risk assessment according to a first embodiment of the invention;

FIG. 6 illustrates audit components for performing an audit risk assessment according to the first embodiment of the invention;

FIG. 7 illustrates different phases of risk assessment in which the first embodiment of the invention can be utilized;

FIG. 8 illustrates a list of audit questions on a GUI screen according to the first embodiment of the invention;

FIG. 9 illustrates a GUI screen showing audit valuation results according to the first embodiment of the invention;

FIG. 10 illustrates a GUI screen showing an audit monitor according to the first embodiment of the invention;

FIG. 11 illustrates a knowledge management platform that can be utilized in the first embodiment of the invention;

FIG. 12 illustrates an example of risk assessment performed for a prospect according to the first embodiment of the invention;

FIG. 13 illustrates an example of an opportunity check that is performed on an existing client, according to the first embodiment of the invention;

FIG. 14 illustrates a complex situation in which possible conflicts can be determined by using the risk assessment tool according to the first embodiment;

FIG. 15 illustrates a risk assessment output that may be provided according to the first embodiment of the invention; and

FIG. 16 illustrates an example of how data can entered into the risk assessment tool according to the first embodiment of the invention.

### DETAILED DESCRIPTION OF THE INVENTION

The present invention performs risk assessment analysis to determine whether or not a prospective client or customer should become an actual client or customer or a company or firm.

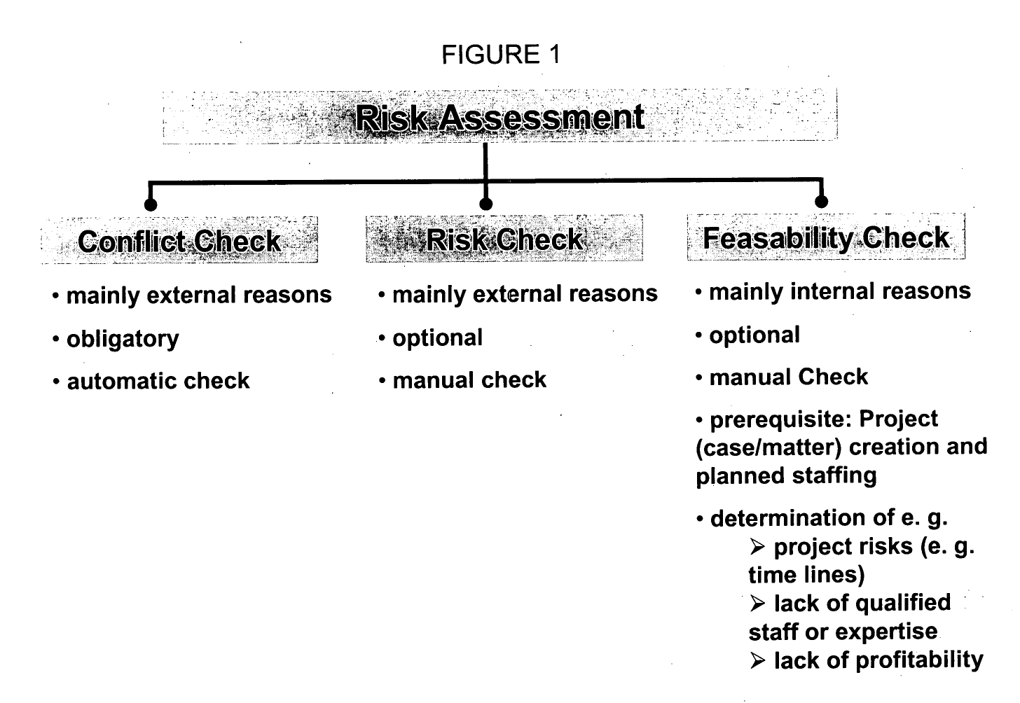

Referring now to FIG. 1, according to a first embodiment of the invention, a risk classification is first performed, whereby a risk assessment is divided up into three risk classification areas: a) conflict check, b) risk check, and c) feasibility check. A conflict check is obligatory, and is performed for mainly external reasons, such as for determining whether or not a prospective new client would be a direct competitor to an existing client of a company or firm. In the first embodiment, the conflict check is done automatically when a prospective new client (and the information related to the prospective new client) are entered into a risk assessment database.

A risk check is optional, and is performed for mainly external reasons. A risk check may involve determining the capacity of a prospective new client to pay for services to be performed for the new client. In the first embodiment, the risk check is done manually.

A feasibility check is also optional, and is performed for mainly internal reasons. It is also done manually. The feasibility check requires that information be entered in the risk assessment database that defines a potential new project (case/matter) and planned staffing for the potential new project. Feasibility determinations may include: a) project risks (e.g., time lines), b) lack of qualified staff or expertise, and c) lack of profitability in accepting the task.

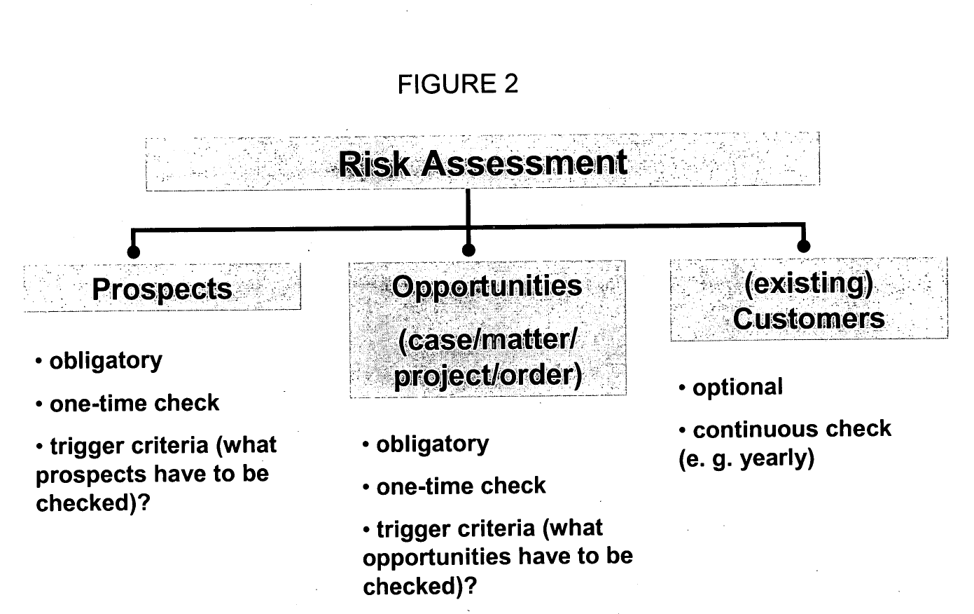

After the risk classification is performed, business objects risk assessment is performed, whereby the business objects risk assessment is divided up into: a) prospects, b) opportunities (case/matter/project/order), and c) (existing) customers. This is shown in FIG. 2. Prospects risk assessment is obligatory, and is preferably performed as a one-time check when an existing client is entered into the risk assessment database. A trigger criteria is assigned for each prospect, to determine which prospects have to be checked.

Opportunities risk assessment is also obligatory, and is also preferably performed as a one-time check. A trigger criteria is assigned with each opportunity, to determine what opportunities have to be checked.

Customers risk assessment, such as for existing customers, is also performed, whereby this is an optional feature and is done periodically, such as once per year.

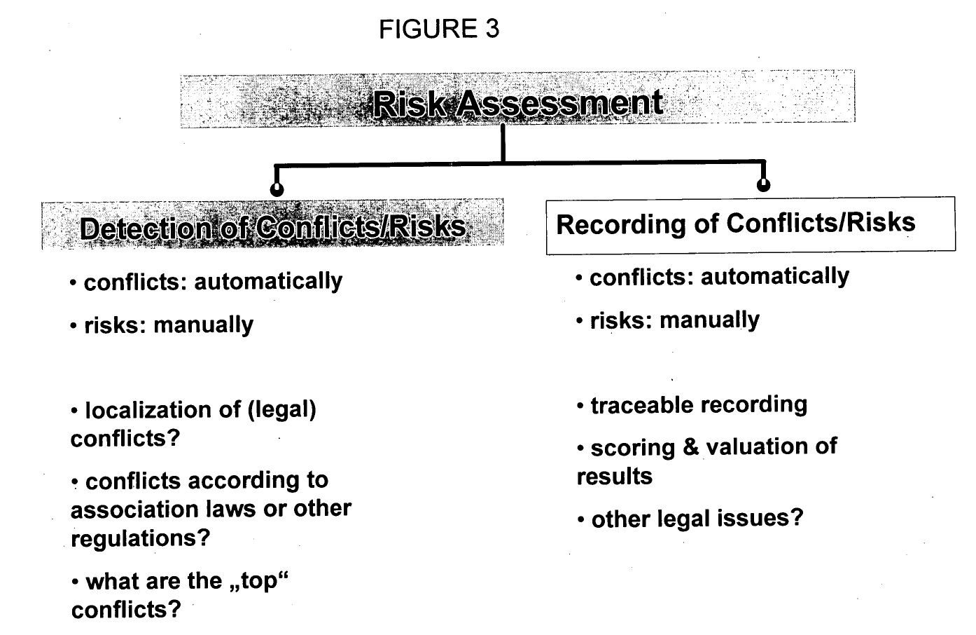

After the business objects risk assessment is performed, a “technical steps” risk assessment is then performed, as shown in FIG. 3. The technical steps risk assessment is divided up into: a) detection of conflicts/risks, and b) recording of conflicts/risks.

For the detection of conflicts/risks, conflicts are detected automatically by the risk assessment tool, and risks are detected manually. Detection may include: a) localization of (legal) conflicts, b) conflicts according to associated laws or other regulations, and c) prioritization of conflicts and risks.

For the recording of conflicts/risks, conflicts are recorded automatically by the risk assessment tool and risks are recorded manually. The recording is preferably done so that each recording is traceable to the risk assessment database, whereby the recording information includes scoring and valuation of results and other (e.g., legal) issues.

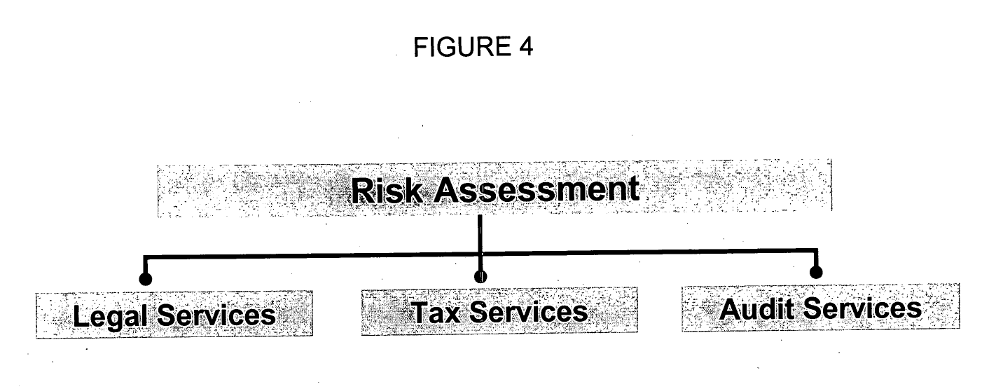

The present invention is capable of providing risk assessment for various purposes, including by not limited to: a) legal services, b) tax services, and c) audit services, as shown in FIG. 4.

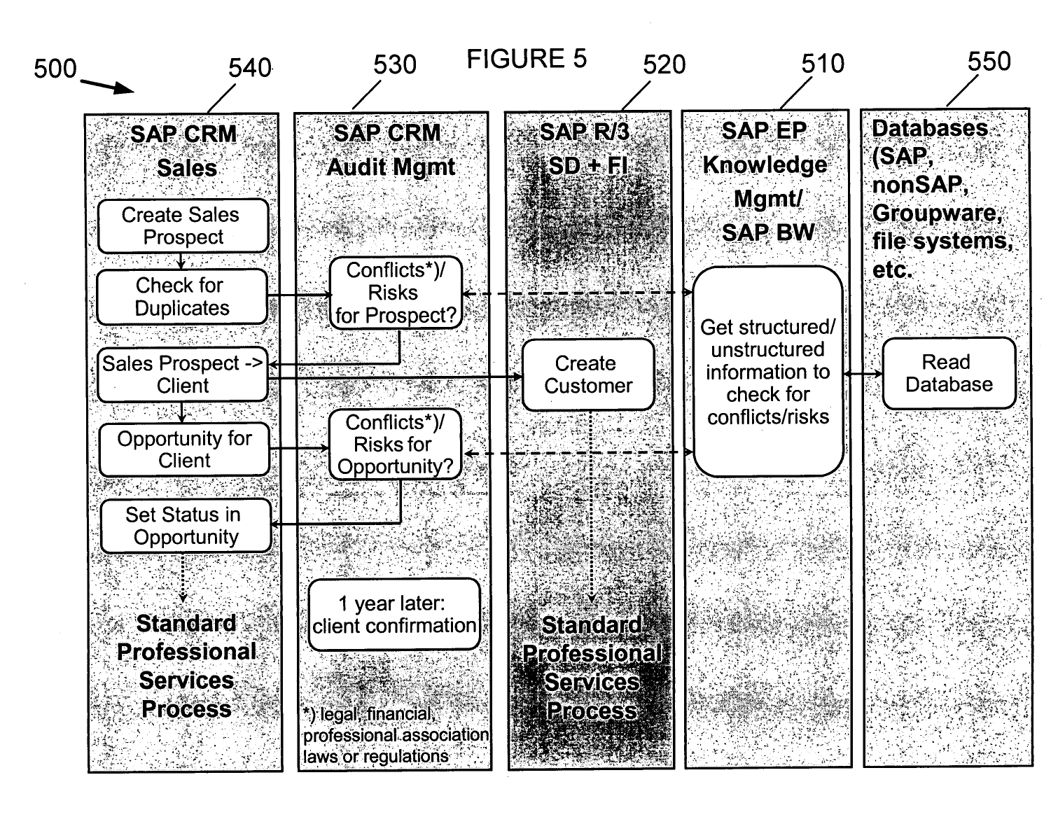

FIG. 5 shows the steps and databases involved in risk assessment for a client and an opportunity according to the first embodiment of the invention.

The present invention determines risks due to conflicts for prospects, such as for a law firm partner who possesses stock certificates or shares of the prospect and/or is member of a supervisory board of the prospect. The present invention also determines risks for prospects themselves, such as the prospect being a company of public interest or it is in endangerment of imminent bankruptcy. The present invention further determines conflicts for opportunities, such as for a law firm that already appears for the opponent in a matter or where illegal services are required for the prospect. Also, the present invention provides risks for opportunities, such as for new services that have to be provided (e.g., a matter where the law firm has no or very little experience).

In the first embodiment, two roles are primarily involved in the risk assessment process:
1. Services Director (the Services Director has to win new prospects and customers and to find and pursue opportunities)
2. Risk Manager (the Risk Manager performs the conflict and risk checks for prospects and opportunities)

The following components are involved in the risk assessment process according to the first embodiment:
1. CRM (Sales)
2. PLM Audit Management
3. R/3 (SD/FI)
4. SAP BW, SAP EP Knowledge Management

FIG. 5 also illustrates a system for performing risk assessment according to the first embodiment. The system 500 includes a back end system 510 (identified as “BW” or “SAP BW”) and a front end system 520 (identified as “R/3” or “SAP R/3”). In another embodiment, a single integrated system may be used in place of the back end system 510 and the front end system 520. System 500 may be implemented as a single system, a distributed system, or any combination thereof. System 500 may be implemented using a single computing system, a plurality of computing systems, software, hardware, or any other system or combination of systems to perform the functions described herein. System 500 may be used, for example, to perform risk assessment and perform audits.

Back end system 510 is a data repository configured to receive, sort, process, and store risk assessment data, as well as to facilitate planning, provide reporting, and provide other functions associated with risk assessment using one or more functions and/or components.

Front end system 520 is communicatively coupled to back end system 510.

Also shown as part of the system 500 in FIG. 5 is an Audit Management system 530, which performs conflicts/risks determinations for prospects and for opportunities and stores the corresponding information. Further, the system 500 includes a Sales system 540, which is used to receive information related to prospective sales prospects and opportunities.

Still further, risk assessment system 500 includes other databases 550, which includes Groupware, file systems, etc.

Each of the systems 510, 520, 530, 540, 550 in FIG. 5 corresponds to a separate database, and each is capable of communicating with any of the other databases making up system 500.

A risk assessment business process according to the first embodiment involves the following steps (as well as describing whether the Services Director or the Risk Manager performs the particular step):
1. Create a sales prospect [CRM] [Services Director]
2. Check for duplicates [CRM, preferably using 3^{rd} party products] [Services Director]
3. Check for conflicts or possible risks for the prospect and record them [Audit Mgmt] [Risk Manager]
4. Use Existing Databases (e.g., BW), Knowledge Management or other sources of information (e.g. internet, telephone calls) to be able to determine conflicts or risks [Risk Manager]
5. If conflicts exist: set status within prospect. [CRM] [Services Director (or Risk Manager)]
If no conflicts exist: convert prospect into customer [CRM] [Services Director]
6. Transfer customer automatically to Front End Database (R/3, ECC) for later process steps [R/3 (ECC)]
7. Create an opportunity for customer [CRM Sales] [Services Director]
8. Check for conflicts or possible risks for the opportunity and record them [Audit Mgmt] [Risk Manager]
9. Use Existing Databases (e.g., BW), Knowledge Management or other sources of information (e.g. internet, telephone calls) to be able to determine conflicts or risks [Risk Manager]
10. Set status in opportunity and continue opportunity cycle [CRM Sales] [Services Director]

In the first embodiment, the Services Director, who creates a prospect, informs the Risk Manager (via CRM activities) to create a new audit for a prospect manually. This step can alternatively be automated, so that during saving of a prospect the corresponding audit is generated. The following information can be gathered automatically:
a) Decision, whether audit is to be generated or not→derived within customer exit
b) Which audit template?→derived within customer exit
c) Audit object=prospect. Audit object number filled from prospect. Audit ID should contain prospect number as well
d) Planned start→filled with actual date
e) Audit partner role Risk Manager→to be determined by standard CRM functionality and filled in automatically
f) Other fields (e.g. audit type, audit trigger, grouping, search field) are filled from the audit template
g) Customer exit feature to be able to pre-answer some audit questions

In the first embodiment, the Services Director, who creates an opportunity, informs the Risk Manager (via CRM actions that create CRM activities) to create a new audit for an opportunity manually. This step can alternatively be automated, so that during activation of a CRM action within an opportunity the corresponding audit is generated. The following information can be gathered automatically:
a) Decision, whether audit is to be generated or not→derived within customer exit
b) Which audit template?→derived within customer exit
c) Audit object 1=customer. Audit object 1 number filled with customer number (taken from opportunity).
Audit object 2=opportunity. Audit object 2 number filled with opportunity number. Audit ID should contain opportunity number as well
d) Planned start→filled with actual date
e) Audit partner role Risk Manager→to be determined by standard CRM functionality and filled in automatically
f) Other fields ((e.g. audit type, audit trigger, grouping, search field) are filled from the audit template
g) Customer exit to be able to pre-answer some audit questions

In the first embodiment, an audit risk assessment can be performed, whereby the audit is a systematic examination used to determine whether or not an object meets previously specified requirements. Audits are usually performed using question lists, whereby the results are valuated and documented.

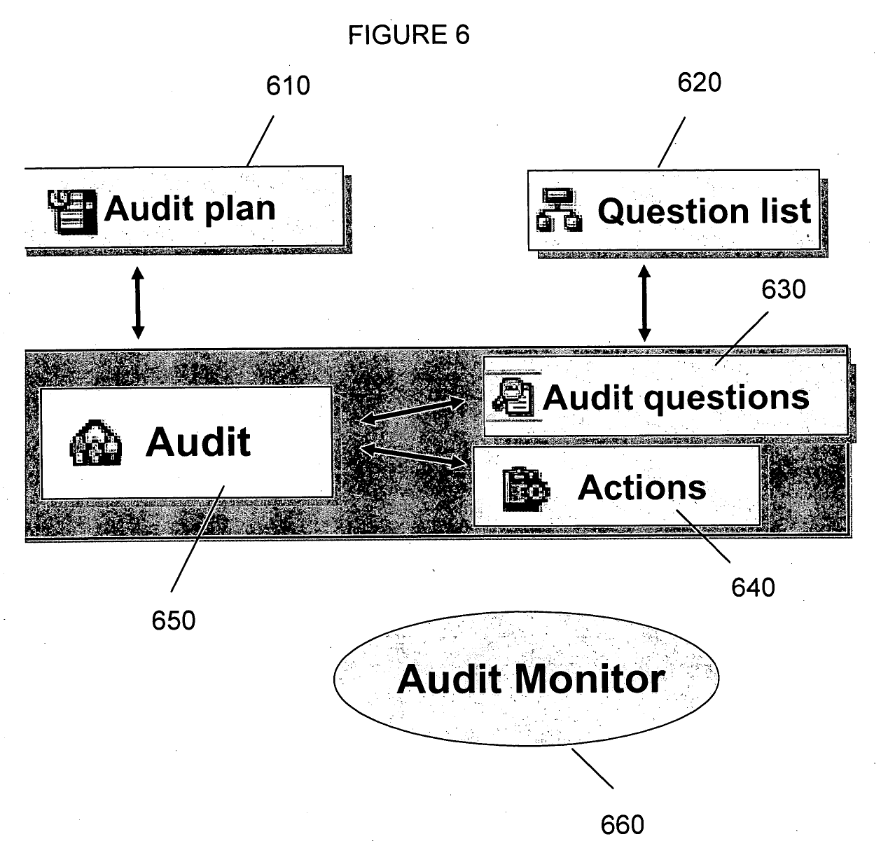

FIG. 6 shows audit components that are used for performing an audit risk assessment according to the first embodiment. An audit plan 610 is created in an audit planning mode, whereby a question list 620 is also created in the audit planning mode. In the audit processing mode, an audit is performed on the audit, whereby audit questions 630 (as obtained from the question list 620) and audit actions 640 are input to the audit module 650. An audit monitor 660 is utilized in an audit monitoring mode, to monitor the results of the audit output by the audit module 650.

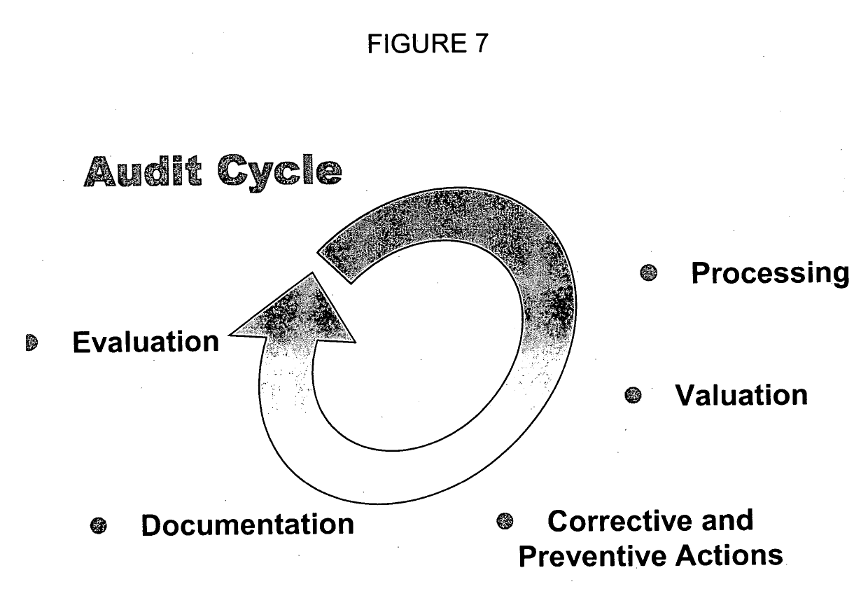

As shown in FIG. 7, an audit risk assessment according to the first embodiment can be performed during all phases of operation, including: a) planning, b) processing, c) valuation, d) corrective and preventive actions, e) documentation, and f) evaluation.

An audit plan risk assessment according to the first embodiment can be done on a flexible basis, such as annually, monthly, weekly, etc. The present invention allows for the display of previous audits and relevant documentation in preparation for an impending audit. Different lists of questions can be created or combined for an upcoming audit, in one possible implementation of the first embodiment.

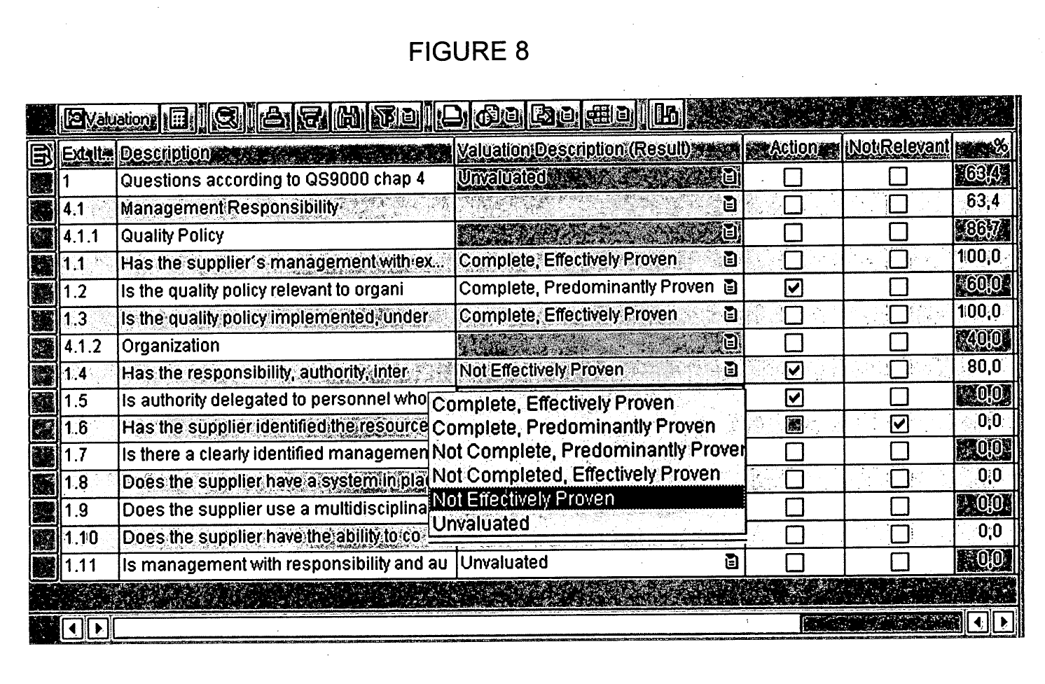

FIG. 8 shows a list of online recording of audit questions, according to one possible implementation of the first embodiment. Each audit question is described under the “description” column, whereby each audit question is provided a valuation description, which is preferably provided by way of a drop down menu on a graphical user interface (GUI) screen. Also, an ‘Action’ column and a ‘Not Relevant’ column are provided on the GUI screen for each audit question in the audit risk assessment.

Valuation Descriptions may include: a) not effectively proven, b) completely effectively proven, c) yes or no, d) no deviation, e) significant deviation, f) critical, etc. Other valuations can be set up in customizing.

The last column in FIG. 8 includes a quantitative valuation, whereby a numerical value is assigned to each valuation. For example, a percentage value from 0% to 100% may be provided as a valuation metric.

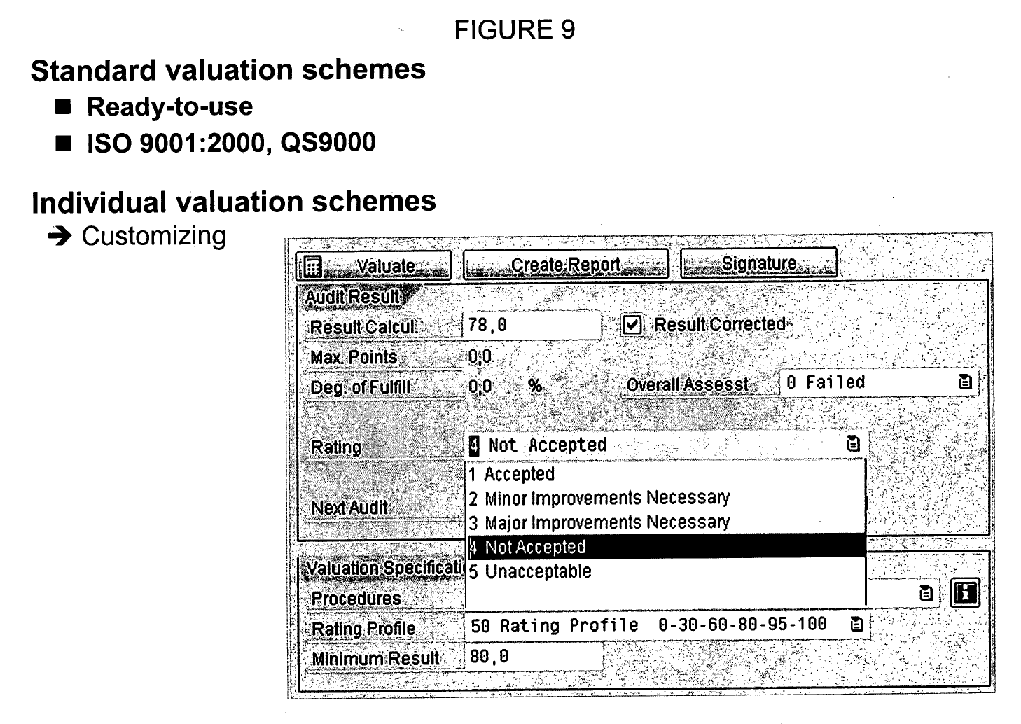

FIG. 9 shows one possible implementation of a GUI screen showing audit valuation results, according to the first embodiment. In FIG. 9, a results calculation box provides a results valuation, based on a total of valuations shown in FIG. 8. Based on the audit valuation result, a rating can be assigned automatically to the audit, however this can be changed by way of a pull-down menu in FIG. 9. The user can select, e.g.: a) accepted, b) minor improvements necessary, c) major improvements necessary, d) not accepted, or e) unacceptable. Other ratings can be set up in customizing.

In the present invention, audit valuation is based on a selection list for questions, whereby the content of the selection list can be freely defined and sorted by a user, and whereby a certain number of points are assigned to each answer to each question.

Questions in the list can be individually weighted and/or prioritized, in an alternative implementation of the first embodiment.

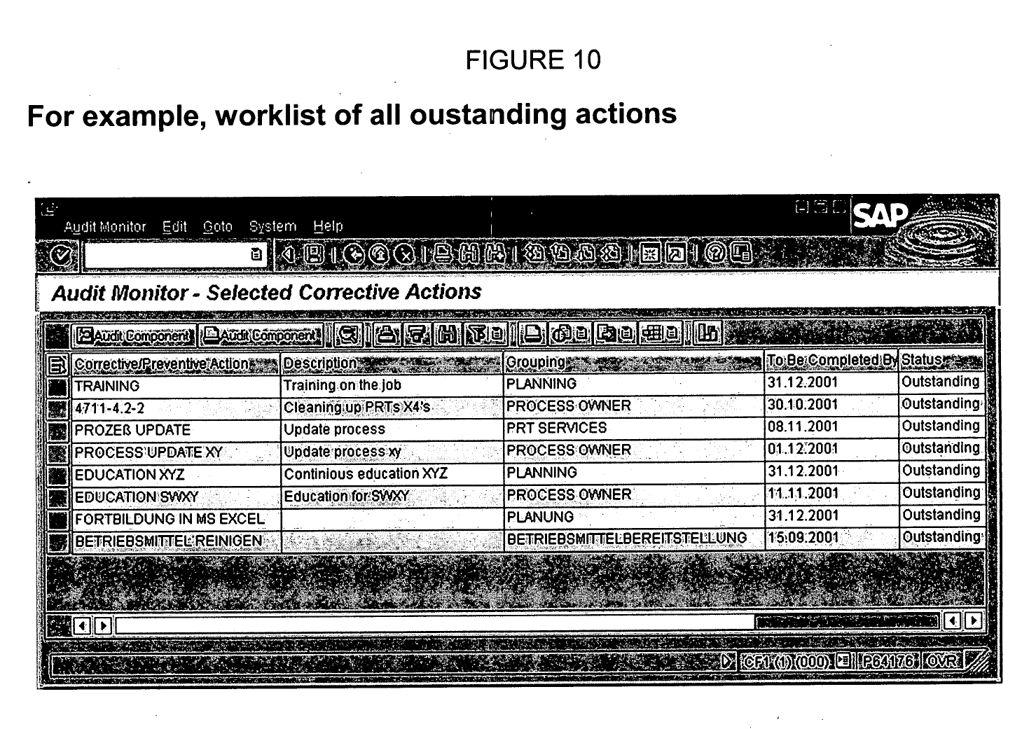

FIG. 10 shows a GUI screen of an audit monitor according to the first embodiment, whereby a first column on the GUI screen provides “corrective/preventive action”, a second column on the GUI screen provides “description”, and third column on the GUI screen provides “grouping”, a fourth column on the GUI screen provides “to be completed date”, and the fifth column on the GUI screen provides “status”.

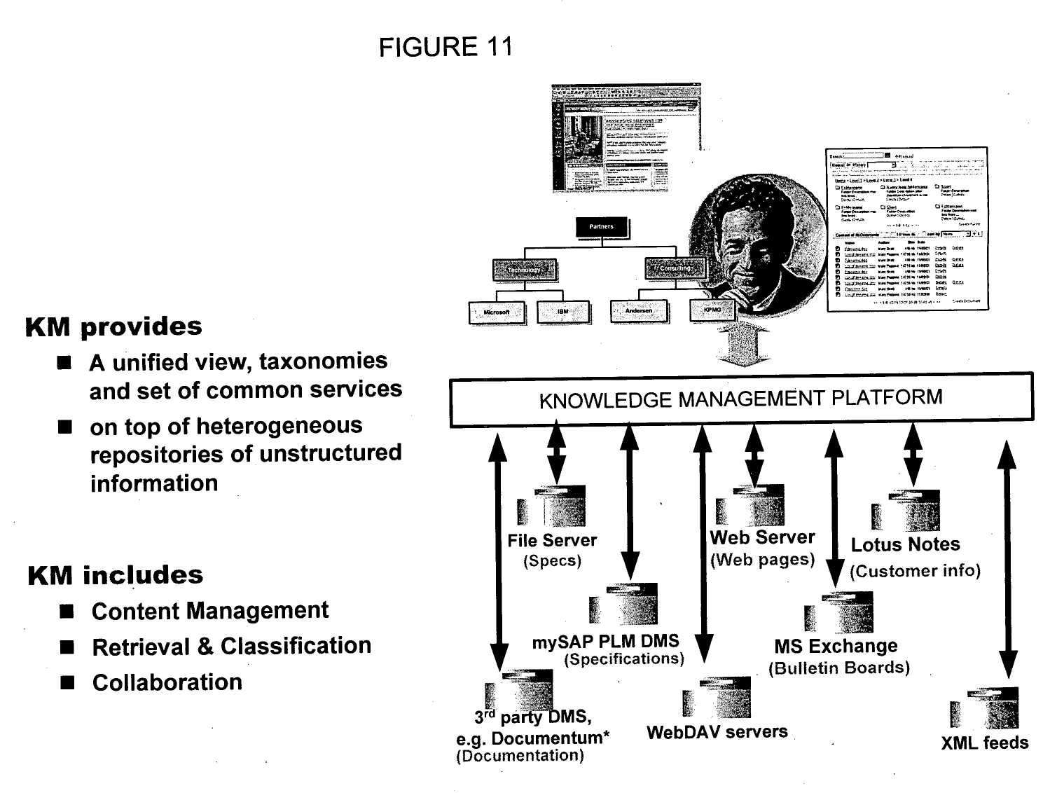

FIG. 11 shows features of a Knowledge Management platform that corresponds to one of the databases shown in FIG. 5. The Knowledge Management platform obtains, e.g., information from: a) third parties (e.g., via a Documentum application), b) file servers, c) Web-based servers, d) Internet Bulletin Boards (e.g., via Microsoft Exchange application), e) customer information (e.g., from Lotus Notes application, and f) XML feeds.

The Knowledge Management platform includes: a) content management features, b) retrieval and classification features, and c) collaboration features, whereby it essentially centralizes all information in a single repository.

In more detail, the Knowledge Management platform provides unified access across multiple document stores. For example, if provides a unified Application Program Interface (API) for different types of repositories, whereby a broad set of connectors can be extended by partners, and whereby it can be integrated into an Enterprise Portal, such as an SAP Enterprise Portal.

The content management services include: browsing, searching, check-in/check-out, subscription, etc. The retrieval and classification services include: indexing and searching, automatic classification, and text mining.

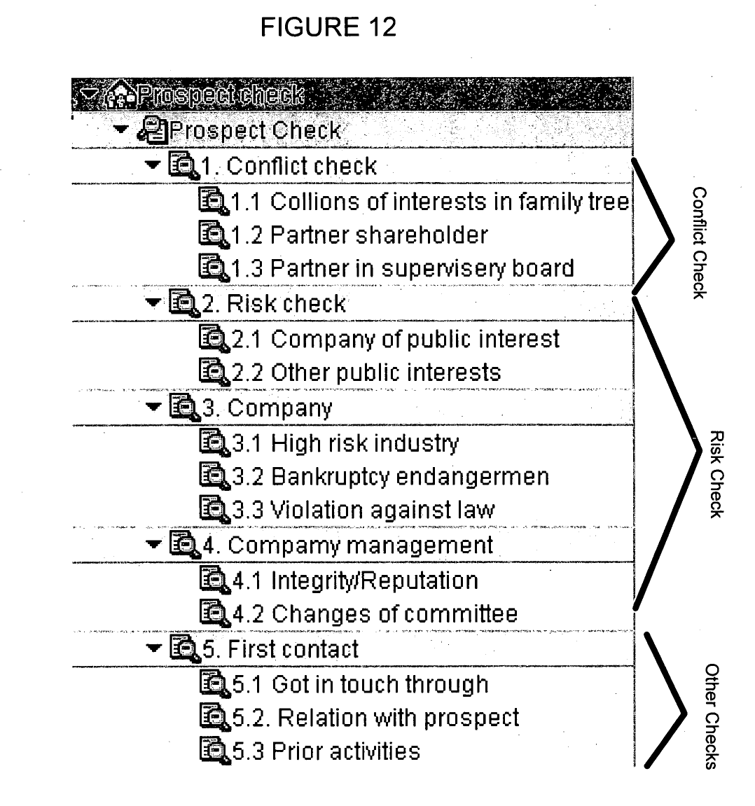

FIG. 12 shows an example of risk management performed for a prospect, according to a first embodiment of the invention.

A prospect check is performed by first doing a conflict check on the prospect. The conflict check includes determining answers to the following questions: a) collisions of interests in a family tree, b) partner shareholder, and c) partner in supervisory board. This conflict check is obligatory.

As a second step, a public interest determination is made on the prospect, whereby this is part of an optional risk check. The public interest questions provided (to be answered) include: a) company of public interest, b) other public interests.

As a third step (also part of the optional risk check), the following questions on the prospect company are provided (to be answered): a) high risk industry, b) bankruptcy endangerment, c) violation against law.

As a fourth step (also part of the optional risk check), the following questions on the prospect company management are provided: a) integrity/reputation, b) changes of committee.

Lastly, as a fifth step, which is part of the other checks/information which is an optional feature of the risk assessment, questions on the first contact with the prospect are provided (to be answered): a) how they got in touch with the prospect, b) relationship with the prospect, c) prior activities with the prospect.

Based on the answers provide to these questions, a risk assessment of the prospect can be made, whereby a valuation can be given for the prospect, to determine whether or not the prospect should become a client of the firm or company doing the risk assessment.

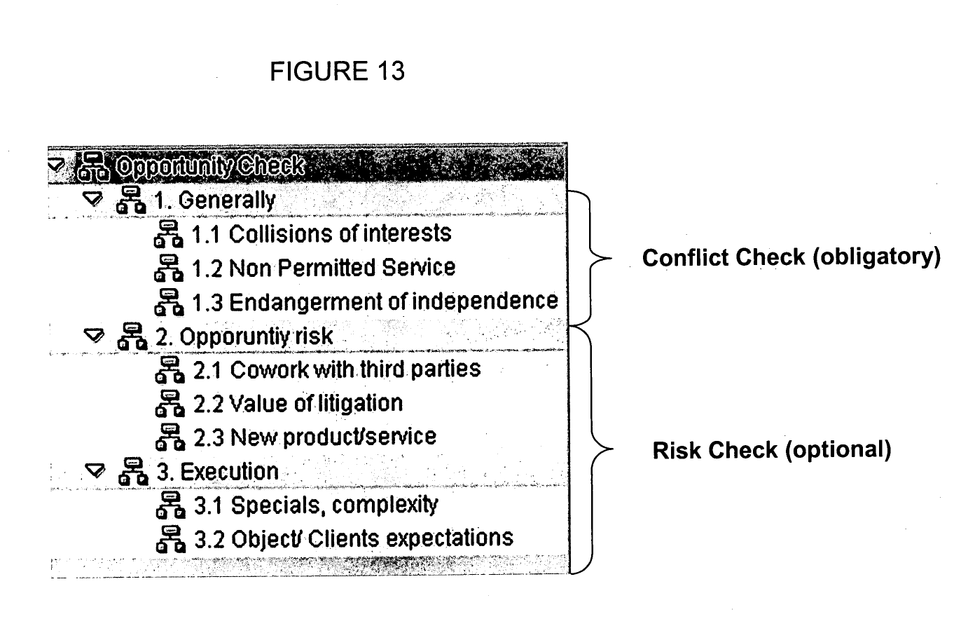

FIG. 13 shows an example of an opportunity check performed on an existing client of a company or firm, to determine whether or not the prospective opportunity should be taken on by the company or firm.

In a first step, which is part of the obligatory conflict check, general questions are provided on a GUI screen with respect to the prospective opportunity (to be answered): a) collisions of interest, b) non-permitted service, c) endangerment of independence.

In a second step, questions related to opportunity risk are provided on the GUI screen (to be answered): a) co-work with third parties, b) value of litigation, c) new product/service. The second step is part of an optional risk check for the opportunity.

In a third step, questions related to execution of the prospective opportunity are provided on the GUI screen (to be answered): a) specials, complexity, b) object/client expectations. The third step is also part of the optional risk check for the opportunity.

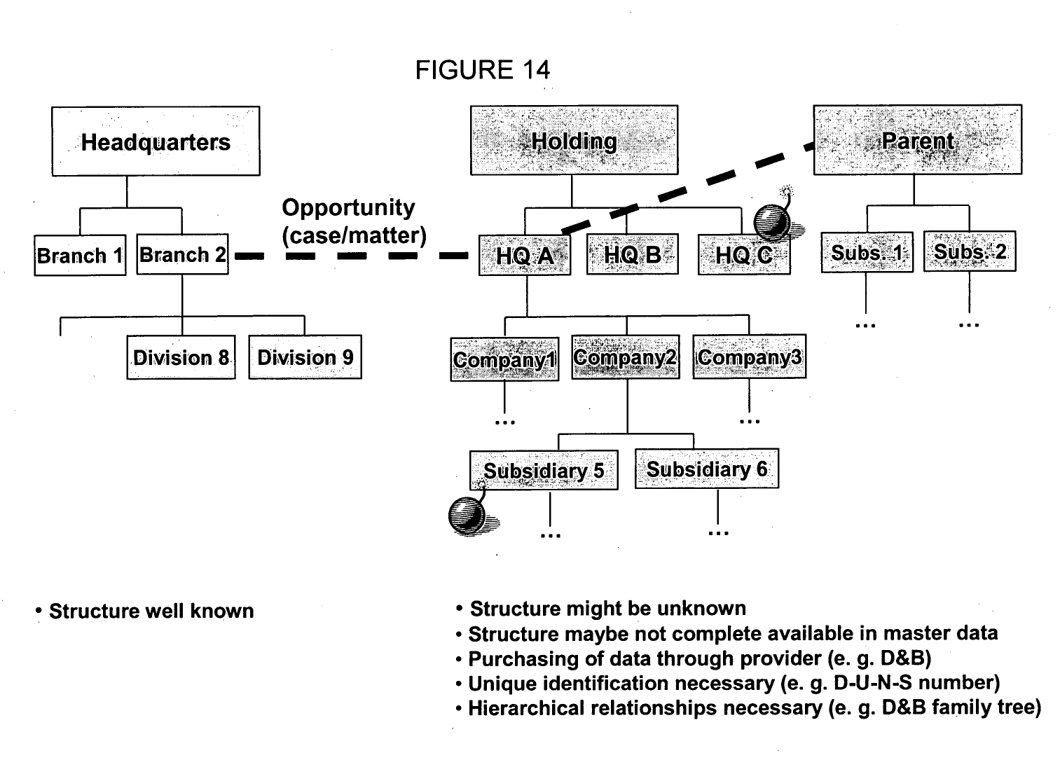

FIG. 14 shows a complex situation in which possible conflicts can be determined by the risk assessment tool according to the first embodiment. In FIG. 14, a risk assessment for potential legal services to be performed for a Prospect is determined. The Service Provider that is to perform the legal service has a Headquarters, Branch 1, Branch 2, and Divisions 7, 8 and 9. An opportunity with respect to a Prospect is provided to the Service Provider, whereby a case/matter is assigned to that opportunity. The Prospect has three separate headquarters A, B, C, whereby Headquarters A has three separate companies 1, 2 and 3 under it alone, and whereby Company 2 has Subsidiary 5 and Subsidiary 6 under it.

In the structure shown in FIG. 14, the opportunity is for legal services for the Prospect against an Opponent, whereby information on the Opponent is also included. In this case, Headquarters A of the Prospect is suing the Opponent, whereby the Opponent includes a Parent company, and two subsidiaries. It is possible that some information on the Opponent is unknown.

Based on all that data inputted to a risk assessment database, a determination is made as to whether or not this prospective opportunity can and should be accepted by the Service Provider.

In FIG. 14, hierarchical relationships for the Service Provider, the Prospect and the Opponent are entered into the risk management database(s) and stored in a hierarchical manner. The hierarchical information may be obtained by using a family tree provided by a third-party service such as Dunn & Bradstreet.

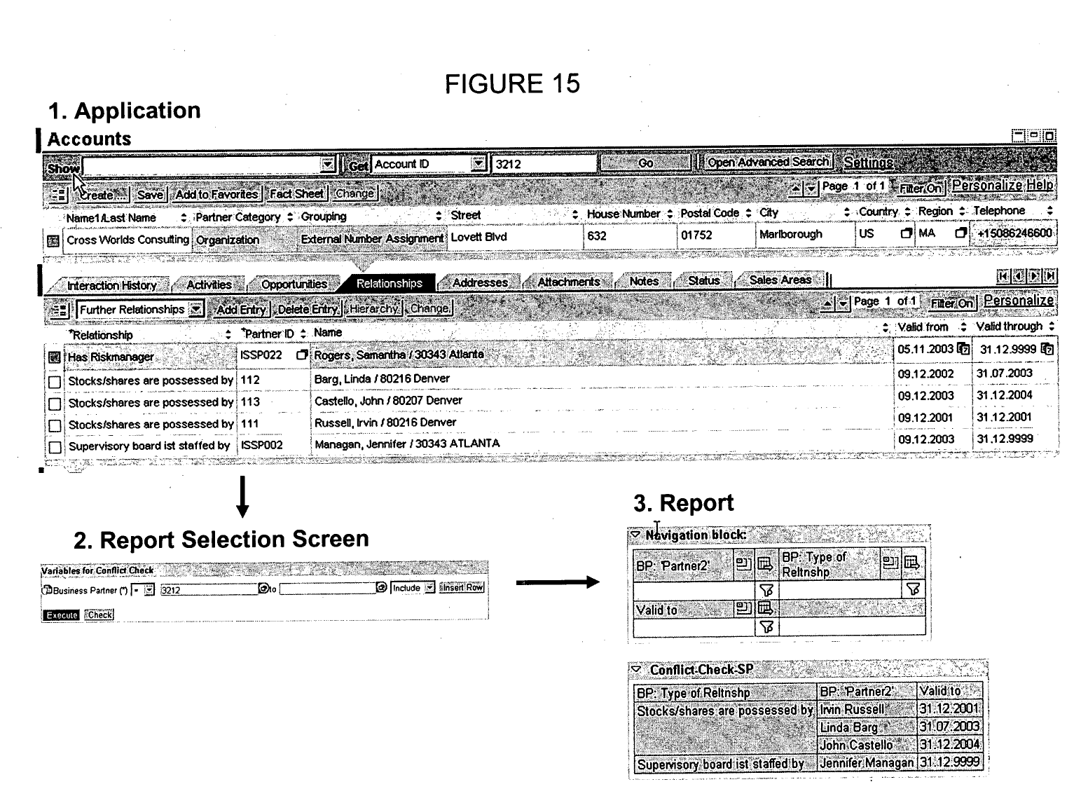

FIG. 15 shows a risk assessment output provided by the risk assessment tool according to the first embodiment, for one example risk assessment. In this risk assessment, it is determined that several partners of the service provider own stock in the prospect (e.g., Cross Worlds Consulting as shown in FIG. 15). Such information is important in determining whether or not the prospect can be accepted by the Service Provider, and/or whether or not the partners need to sell their stock in the prospect prior to taking the prospect on as a new client.

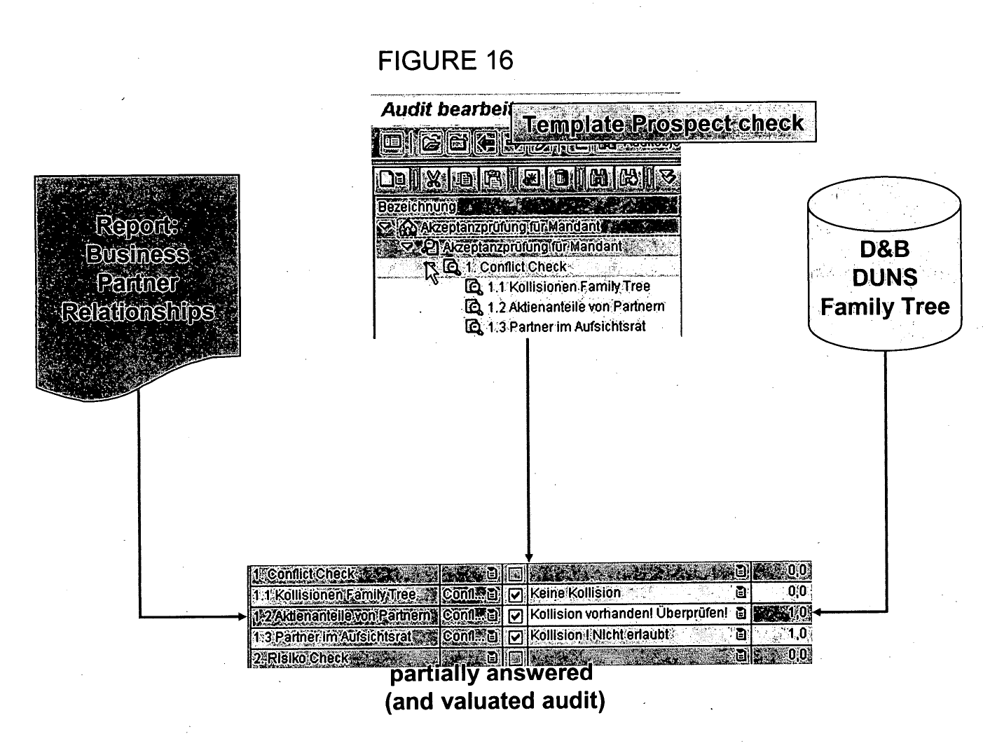

FIG. 16 shows how data is inputted into a risk assessment tool according to the first embodiment. In FIG. 16, reports that contain business partner relationships are inputted to a risk assessment database, and also company family tree information (e.g., such as obtained from Dunn & Bradstreet) is also inputted to the risk assessment database. From this input data, a conflicts check can be performed.

One aspect of the first embodiment is the proper creation of questions to be used for the question lists, whereby the questions shown in the figures are exemplary of the types of questions that should be answered in order to obtain useful risk assessment results. Such questions may be obtained by persons experienced in performing conflicts checks, and/or by other people in a company or firm who are knowledgeable as to issues with respect to different areas of the law.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A method of performing risk assessment for a service provider, comprising:
creating a sales prospect;
determining conflicts and risks for the prospect based on answering a plurality of questions relating to the prospect;
determining whether or not the prospect should be allowed as a new client based on the determined conflicts and risks;
wherein, if the prospect is determined to be allowable as a new client:
determining conflicts and risks for an opportunity to be performed for the prospect based on answering a plurality of questions related to the opportunity; and
based on the determined conflicts and risks, either accepting the opportunity or not accepting the opportunity.

2. The method according to claim 1, wherein the plurality of questions include questions related to persons working for the service provider and their relationships to the prospect.

3. The method according to claim 1, wherein the plurality of questions include questions related to monetary strength of the prospect.

4. The method according to claim 1, further comprising:
performing an audit for the service provider by providing answers to a plurality of questions related to a particular audit.

5. The method according to claim 4, further comprising:
inputting an audit plan and the answers to the plurality of questions to an audit module.

6. The method according to claim 4, further comprising:
performing monitoring of the audit on a periodic basis.

7. The method according to claim 1, wherein the plurality of questions are provided on a graphical user interface screen, for answering by at least one user.

8. The method according to claim 7, wherein the plurality of questions are each assigned a particular priority level, and wherein the answers to the plurality of questions are also assigned the corresponding priority level.

9. The method according to claim 8, wherein the risk assessment is computed as a percentage value based in part on the answers to the plurality of questions.

10. A system for performing risk assessment for a service provider, comprising:
a first database for creating a sales prospect;
a second database for determining conflicts and risks for the prospect based on answers to a plurality of questions relating to the prospect;
wherein the first database determines whether or not the prospect should be allowed as a new client based on the determined conflicts and risks; and
a third database for creating a new customer corresponding to the prospect when the first database determines that the prospect should be allowed as a new client.

11. The system according to claim 10, wherein the first database inputs information corresponding to a new opportunity for the prospect,
wherein the second database determines conflicts and risks for the opportunity based on answers to a plurality of questions relating to the opportunity, and
wherein, if the opportunity is determined to be accepted based on the determined conflicts and risks, the opportunity is entered as a new opportunity in the first database.

12. The system according to claim 10, wherein the plurality of questions include questions related to persons working for the service provider and their relationships to the prospect.

13. The system according to claim 10, wherein the plurality of questions include questions related to monetary strength of the prospect.

14. The system according to claim 10, further comprising:
a fourth database for performing an audit for the service provider by providing answers to a plurality of questions related to a particular audit.

15. The system according to claim 14, further comprising:
means for performing monitoring of the audit on a periodic basis.

16. The system according to claim 10, wherein the plurality of questions are provided on a graphical user interface screen, for answering by at least one user.

17. The system according to claim 16, wherein the plurality of questions are each assigned a particular priority level, and wherein the answers to the plurality of questions are also assigned the corresponding priority level.
